(19) United States
(12) Patent Application Publication
(10) Pub. No.: US 2009/0197233 A1
(43) Pub. Date: Aug. 6, 2009

(54) Method and System for Test Administration and Management

(75) Inventors: David P. Rubin, Menlo Park, CA (US); Matthew Serrano, Menlo Park, CA (US); Victor Chugonov, Palo Alto, CA (US); Ramsin Gundalove, San Jose, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ORDINATE CORPORATION, Menlo Park, CA (US)

(21) Appl. No.: 12/027,206

(22) Filed: Feb. 6, 2008

(51) Int. Cl. G09B 7/00; G06F 15/16

(52) U.S. Cl. 434/322; 709/219

(57) ABSTRACT

Methods and systems are disclosed for test administration and management. A server or server system presents an interface to a client web browser over a network. A user of the client web browser selects a test taker, a test, and a destination identifier. The server or server system may then present the test to the test taker in a call to the destination identifier. After completion of the test, the server or server system may then score the test and display the score of the test in the interface. The interface may also allow the user to play back a recording of a completed test. The interface may support multiple test takers or multiple tests.

### BACKGROUND

Testing as a means of evaluation has application in a variety of contexts. For example, schools or educational institutions may test students to enable decisions regarding advancement, curriculum, remedial study, and graduation. Additionally, a business may test job applicants or current employees to determine their suitability for a new or advanced position.

Most testing processes may be divided into multiple stages. After a test has been developed, the completed test may be administered to a test taker. Once the test taker completes the test, that test may be scored, either by a person or by a computer. After the completed test has been scored, a test administrator, such as a classroom teacher, may provide the test taker with test results, including a score. The test taker or the test administrator may then interpret the test results and plan a further course of testing or study based on the results.

Test management may involve tracking test results, for example, by test taker or by test subject matter. A test administrator may be responsible for managing the testing processes for multiple test takers, such as would be the case with a classroom teacher who has multiple students engaged in testing at one time. Additionally, a test taker may be engaged in multiple courses of testing at one time; for example, an individual learning multiple languages at once may chart his or her own progress using tests for each language.

Reading fluency, or the proficiency with which the written word is accurately read aloud, is one attribute that may be tested. A reading fluency test may involve a person reading aloud from a prescribed text. Another person may listen to the reader and subjectively evaluate the reader's fluency. Alternatively, a recording may be made of the reader reading, and that recording may be used by a person or a computer to evaluate the reader's proficiency.

### SUMMARY

An exemplary method for test administration and management begins with a client web browser sending a request to a web address, and a server then responds to the request by sending to the client web browser a document defining an interface. The interface, identifying a test taker list and a test list, supports multiple functions related to test administration and management. The interface supports at least the selection of a dial-out phone number, the presentation of a test from the test list to a test taker from the test taker list in a phone call to the dial-out phone number, and the display of a score for the test.

Another exemplary method begins with a client web browser sending a request to a web address and a server system responding to the request by sending to the client web browser a document defining an interface. The interface identifies a test taker list, a test list, and a dial-out phone number list. A user of the client web browser then selects a test taker, a test, and a dial-out phone number through the interface. In response to these selections, the server system presents the test to the test taker through a phone call to the dial-out phone number. The server system records the phone call and determines a score of the test. After the test is scored, the server system updates the interface to display the score of the test and to allow the user to playback the recording.

An exemplary system for test administration and management comprises a client device connected to a data network, an application server connected to the data network, and a voice communication server communicatively connected to the application server and to a voice communication network. The client device is loaded with a web browser. The application server comprises logic to cause the client device to display an interface via the web browser; to receive from the client device, via the interface, a request to present a test, wherein the request comprises a test identifier, a test taker identifier, and a destination identifier; and to send a test, corresponding to the test identifier, with the destination identifier to the voice communication server for presentation to the test taker, corresponding to the test taker identifier, over the voice communication network.

These, as well as other aspects and advantages, will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Certain examples are described below in conjunction with the appended drawing figures, wherein like reference numerals refer to like elements in the various figures, and wherein:

FIG. 1 is a block diagram of an exemplary system for test administration and management;

FIG. 2 is a flow diagram depicting an exemplary method of test administration and management; and

FIG. 3, 4, 5, and 6 are screen displays for an exemplary interface for test administration and management.

### DETAILED DESCRIPTION

Test administration and management may be implemented in any system or environment in which individuals are tested. The methods and systems disclosed herein provide for test administration and management using a server or system of servers interacting with a client device or devices.

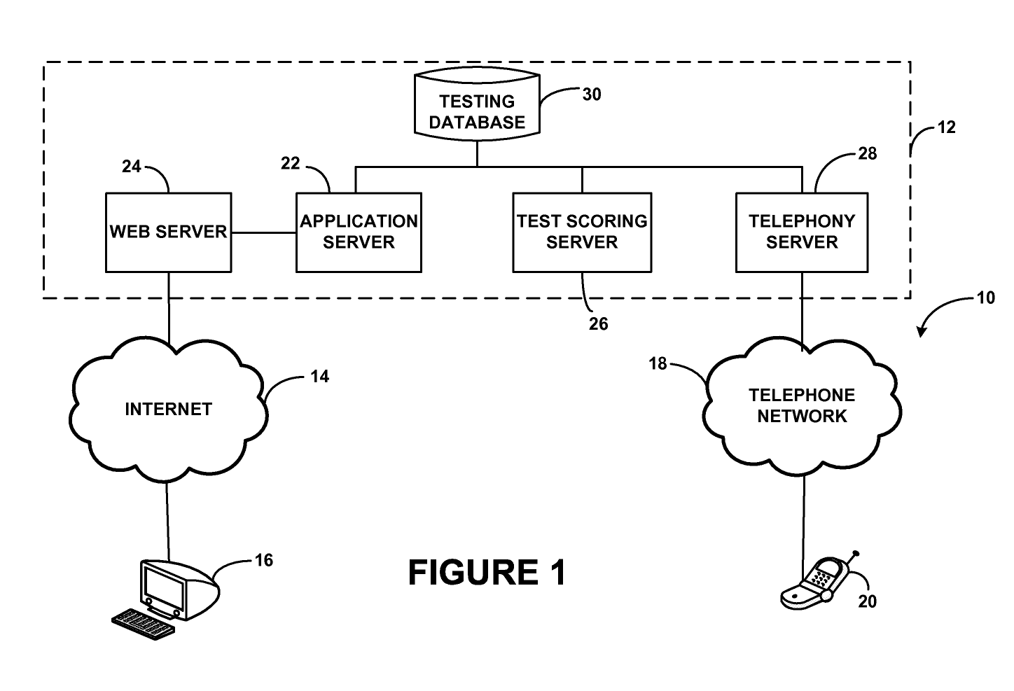

FIG. 1 depicts an exemplary system 10 for test administration and management. System 10 includes a server system 12 connected to a data network 14 and a voice communication network 18, a client device 16, and a telephone 20. Data network 14, shown as the Internet, may connect server system 12 to client device 16. Voice communication network 18, shown as a telephone network, may connect server system 12 to telephone 20. Data network 14 and voice communication network 18 could be the same network, for example, when voice-over Internet Protocol (VoIP) is used for voice communications.

In an exemplary embodiment, server system 12 comprises four servers, an application server 22, a web server 24, a test scoring server 26, and a voice communication server 28, and also includes a testing database 30. The servers in server system 12 may include logic, processing elements, memory, and other computing capabilities, as needed, and may be consolidated or distributed into any number of server elements. Application server 22 may control the test administration and management system and may be communicatively linked to every other server in server system 12. Web server 24 may link application server 22 with data network 14 and may facilitate information from application server 22 being accessible through data network 14 at one or more web addresses. Test scoring server 26 may be configured to score tests. Voice communication server 28, shown as a telephony server, may link application server 22 to voice communication network 18 and may deliver tests through voice communication network 18. Testing database 30 may be accessible by servers within server system 12 and may contain information about tests and test takers, including lists of each.

It is to be understood that the configuration of server system 12 shown in FIG. 1 is exemplary only. The functions of controlling test administration and management, facilitating information accessibility on data network 14, scoring tests, delivering tests through voice communication network 18, and containing information about tests and test takers could be provided by a greater or fewer number of servers, databases, or other elements in server system 12.

Client device 16 may be connected to data network 14. Client device 16 may be a personal computer, a personal digital assistant, a mobile phone, or any other device that can send and receive data using data network 14. Client device 16 may be equipped with an accessibility program, such as a web browser, that allows client device 16 to access information via data network 14.

Telephone 20 may be connected to, and receive calls through, voice communication network 18. Telephone 20 may be a cellular telephone, a personal digital assistant, a landline telephone, or any other device with voice capability and connectivity with voice communication network 18.

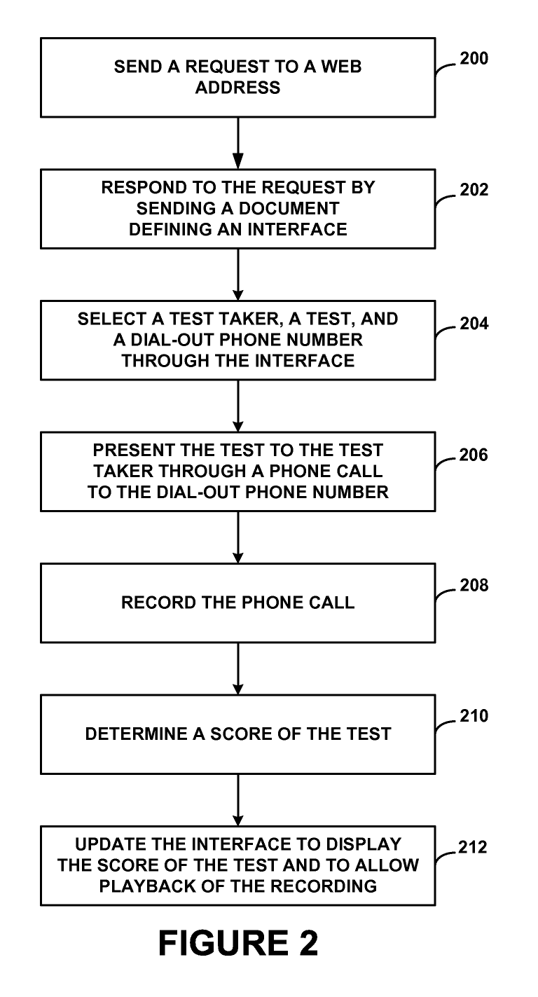

FIG. 2 is a flow diagram depicting an exemplary method of test administration and management. The steps in FIG. 2 are discussed herein using the entities shown in FIG. 1, but the method steps may be performed by any appropriate entity. Additionally, steps may be combined, changed, moved, added, and deleted without departing from the true scope and spirit of the invention.

In step 200, client device 16 may send, using a web browser, a request to a web address in data network 14. Web server 24 may recognize the request as corresponding to a web address associated with the test administration and management system and may inform application server 22 of the request. In step 202, application server 22 may respond to the request by sending a document through web server 24 and data network 14 to client device 16. The document may define an interface for a user of client device 16. As an example, the document defining the interface could be a HyperText Markup Language (HTML) document or an Extensible Markup Language (XML) document.

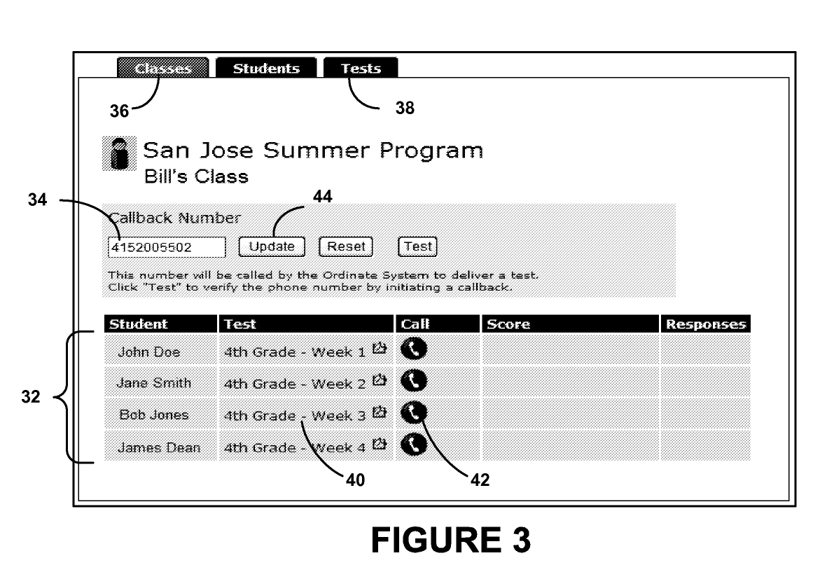

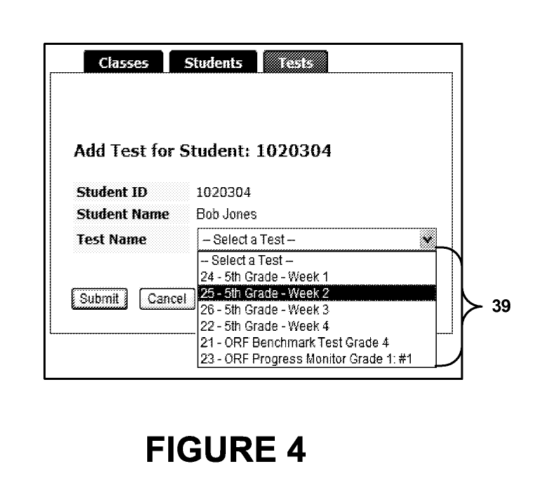

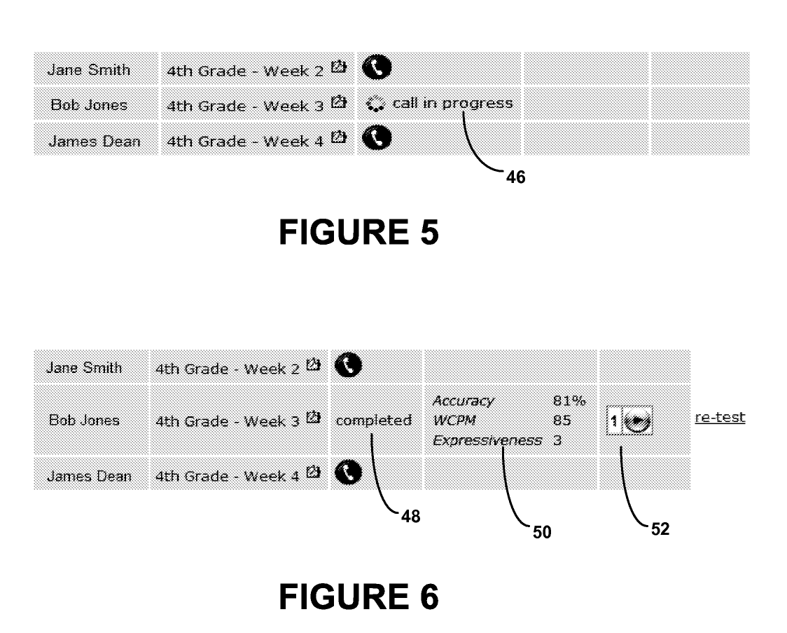

FIGS. 3, 4, 5, and 6 are screen displays for an exemplary graphical user interface (GUI). FIG. 3 shows a test taker list 32, a callback number 34, a classes tab 36, a tests tab 38, a test identifier 40, a phone icon 42, and an update button 44. Test taker list 32 lists individuals who may be selected to receive a delivered test. Callback number 34 is a dial-out phone number that the testing system will call once a test has been selected for delivery. Alternatively, instead of a telephone number, the interface may display a different type of destination identifier, such as an Internet Protocol (IP) address, of a device to which a test may be delivered. FIG. 3 shows a view associated with classes tab 36. In this view, the interface associates test takers in the test taker list with particular tests in the test list.

The user may be allowed to edit the test taker list. For example, the interface may support the user adding or deleting test takers from the test taker list. Also, test takers may be associated into groups, such as the class roster partially shown in FIG. 3, and the interface may support the arrangement of test takers into existing groups or the creation of new groups of test takers. The interface may display the groups of test takers in a hierarchical fashion, such as, in an educational context, by school, by grade, and by teacher. The test taker list may provide the user access to information on test takers, such as age, proficiency rating, and past test performance. The test taker list may also include dummy “test students” to allow the user to become familiar with the tests and the testing system without affecting the testing record of any actual test taker.

A test list lists the tests available for delivery in the testing system. Similar to the test taker list, the test list may be accessible to the user for editing, such that the user may add tests to, delete tests from, or arrange tests in the test list. In FIG. 3, the portions of the test list may be accessed by selecting tests tab 38. FIG. 4 shows a portion 39 of the test list, a portion that includes tests that may be selected for a particular test taker. The test list may provide the user access to information about each test, such as material covered, expected duration, difficulty, and pass rate. In one embodiment, the entire test list may be earmarked for possible delivery to every test taker. Alternatively, selections of the test list may be associated with each test taker based on test taker input, test administrator input, testing recommendations, and test performance.

In FIG. 3, each of the test takers on test taker list 32 is associated with a single test, one of which has test identifier 40. A phone icon 42 appears after a listing of a test taker and a test, and, if a user selects phone icon 42, the system will deliver the test listed with the icon to the test taker listed with the icon. Thus, as indicated in step 204 of FIG. 2, a user of client device 16 may select a test taker, a test, and a dial-out number through the interface. The user and the test taker may or may not be the same person. The user may select test takers and tests by name or number, and these names and numbers may be the same as, or may correspond to, the identifiers the testing system may use to identify test takers and tests. In FIG. 3, if the user wants a dial-out number different from dial-out number 34, the user may input a new number and select update button 44. Alternatively, a variety of dial-out numbers may be presented in a drop-down list for the user to select, and the drop-down list may be populated by dial-out numbers, for example, that have been used to deliver tests or that are associated with cellular telephones used with the testing system. The user may select a test taker and a test, for example, by a single mouse click or a double mouse click on an icon, by a keystroke, or by any other selection event associated with both the test taker and the test. For example, in FIG. 3, the user may select phone icon 42 to deliver the “4th Grade—Week 3” test to the test taker “Bob Jones” listed with the icon.

In one embodiment, the testing system may support the presentation of multiple tests at one time; therefore, the user may be allowed to select multiple test takers at approximately the same time. Alternatively, if the testing system does not support multiple simultaneous test presentations, the interface may still allow the user to make multiple test taker selections, and application server 22 may queue the selections for serial presentation.

The selection of test taker and test may be separated into different icons, different selection events, and different interface views in an alternate embodiment. For example, the interface may contain a test taker tab, from which the user may select a test taker; a test tab, from which the user may select a test; and a dial-out number tab, from which the user may select a dial out number. Additionally, the selection of a test taker may activate a default selection of a dial-out number, perhaps that test taker's phone number, and of a test, perhaps the next test in a preselected sequence of tests. The test taker list, the test list, and the dial-out number may be arranged in any visual or textual format that allows the user to select from them.

In step 206, application server 22 responds to the user's selections by presenting the selected test to the selected test taker. Application server 22 may have the selected test stored or may access testing database 30 to retrieve the selected test. Once it has the selected test, application server 22 may transfer the selected test and the dial-out number to voice communication server 28.

Voice communication server 28 may then present, or deliver, the selected test in a phone call to the dial-out number, over voice communication network 18 to telephone 20, which may correspond to the selected dial-out number. Telephone 20 may be a cellular telephone shared by multiple test takers, and the testing system may assume that, for a particular test presentation, the selected test taker is answering telephone 20. Presentation of the selected test may require voice communication server 28 and application server 22 to work in conjunction with each other to provide proper prompts to the test taker who answers the call and to determine when the test has been completed.

Before or during a test presentation, the test taker may read test instructions from a test booklet. The test booklet may be, for example, a physical booklet or an electronic document, which may be located on a local hard drive, a network drive, a local network, or another data network, for example, data network 14. The test instructions may include a description of the format of the test and an explanation of when and how the test taker should respond to test prompts. In the reading fluency test example, the test booklet may include, along with test instructions, passages for the test taker to read from in response to particular testing prompts.

An exemplary test presentation may involve a test taker answering a call on telephone 20. The test presentation may then proceed according to the test instructions. For example, in the reading fluency test example, the testing system may provide, over the phone, a prompt for the test taker to read from a particular passage. The test taker may then read that passage into telephone 20. After the test taker is finished reading from the passage, or when test taker has reached a time limit for reading the passage, the testing system may prompt the test taker to read another passage. The testing system may also indicate to the test taker when the test has been completed. The testing system or the test taker may then hang up and end the test phone call.

During various phases of test presentation, the interface may be updated to display to the user the current status of a particular test presentation. For instance, in FIG. 5, a status identifier 46 indicates that a test call is in progress presenting the selected test to the selected test taker. Alternative status identifiers may indicate, for example, that a test is completed, that the test taker hung up, that the connection was lost, that a test is being scored, or that the system is dialing the call. In FIG. 6, status identifier 48 indicates that a test call is completed. These status identifiers may be updated by the interface in real-time according to status messages from the entities in the testing system.

According to step 208, voice communication server 28 may record the test. The recording may be a voice recording of the call and may include, for example, all of the prompts and responses, only the responses, or only some of the responses. For instance, a test taker may be prompted to restart a test during a phone call based on an inappropriate volume level, in which case voice communication server 28 may only record the responses given after the test has restarted. The test recording may be used for scoring purposes, may be archived, and may be made accessible to the user or the test taker. In one embodiment, the test taker may be allowed, during the same phone call, to playback the test recording after completion of the test and may be allowed to restart the test if unsatisfied with the recorded test.

In step 210, voice communication server 28 may provide the test recording to test scoring server 26 to determine a score of the test. If the test presented is a reading fluency test, test scoring server 26 may make the score determination based on speech recognition technology, example passage readings, and other indicia of fluency, such as articulation and expressiveness. The score may be a simple pass or fail designation or may comprise other qualitative and quantitative measurements of performance. In the reading fluency example, the score may include a percentage accuracy score, a rate of words read correctly, and a quantification of expressiveness. Test scoring server 26 may provide the test recording and the score and other test results to application server 22.

Additionally, test scoring database 30 may archive the test recording along with other information such as the score, the test results, information about the test taker, the time of the test presentation, and the duration of the test. In one embodiment, the interface may provide access to the archives in the test scoring database and may allow a user to run data analysis on the archives. For example, the user may desire a report on how many test takers have completed a particular test and what portion of those test takers scored above a threshold score an that test, and the interface may assemble that request from the user, may transmit the request to the test scoring database, and may present a report containing the requested information to the user.

In step 212, application server 22 may present information about the completed test to the user though the interface. For example, in FIG. 6, scoring information 50 may be displayed in the interface alongside the test taker and test to which it applies. In one embodiment, scoring information 50 may be summarized in a line item beside the test taker and the test, and the user may make a selection to trigger the interface to display more extensive scoring information. Playback options 52 may also be displayed to the user, and as shown in FIG. 6, playback options 52 may be separated into segments. The user may select playback options 52 to hear the test recording, and the separations of the playback options 52 may correspond to different sections of a test, so the user may select the section of the test that is of interest and only play back that portion of the recording. In one embodiment, the user's request in the interface to play back a recording may cause application server 22 to retrieve the recording from testing database 30 to play for the user over the interface. The interface may present, near the option to play back the recordings, an option to present the test to the test taker again.

The interface may also present testing recommendations to the user. For instance, application server 22 may access the testing records of a particular test taker that are contained in testing database 30 and may analyze the performance trends of that test taker. If the test list is ordered by difficulty, and if a test taker has successfully completed the easiest test in the test list, application server 22 may recommend, via the interface, that the test taker take the next easiest test in the test list. Alternately, if a test taker has performed poorly on the easiest test in a series, application server 22 may recommend an easier series of tests for the test taker. Similarly, if a test taker has performed satisfactorily on all the tests in a series, application server 22 may recommend a different or harder test series. The interface and application server 22 may also track the progression of a test taker through a linear or a branching series of tests that are charted out by the user or another test administrator.

In addition to making testing recommendations specific to a test taker, application server 22 may analyze testing data by test or by group and recommend testing strategies on that scale. For example, if a group of test takers has shown proficiency on a given battery of tests, application server 22 may recommend, through the interface, a new battery of tests appropriate for all or a majority of the test taker group.

A variety of examples have been described above, all dealing with test administration and management. However, those skilled in the art will understand that changes and modifications may be made to these examples without departing from the true scope and spirit of the present invention, which is defined by the claims. For example, the various units of the test administration and management system may be consolidated into fewer units or divided into more units as necessary for a particular embodiment. Additionally, though this disclosure makes reference to reading fluency tests, the inventive test administration and management system and methods may be used with other tests or evaluation tools. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method for accessing a test management system comprising:
a client web browser sending a request to a web address; and
a server responding to the request by sending to the client web browser a document defining an interface, the interface identifying a test taker list and a test list, wherein the server supports the following functions through the interface:
(i) selection of a dial-out phone number;
(ii) presentation of a test from the test list to a test taker from the test taker list in a phone call to the dial-out phone number; and
(iii) display of a score for the test.

2. The method of claim 1, wherein each test taker in the test taker list is associated with one or more icons identifying one or more tests from the test list.

3. The method of claim 2, wherein presentation of a test from the test list to a test taker from the test taker list in a phone call to the dial-out phone number occurs in response to a selection, within the interface, of an icon, representing the test, that is associated with the test taker.

4. The method of claim 1, wherein the test taker list includes information associated with each test taker, and wherein the server further supports arrangement of the test taker list according to the information.

5. The method of claim 1, wherein selection of a dial-out phone number comprises selection of a phone number from a list of phone numbers.

6. The method of claim 1, further comprising the server recording the test taker taking the test.

7. The method of claim 6, wherein the server further supports playback of the test recording through the interface.

8. The method of claim 1, wherein the server further supports the following functions:
(iv) revision of the test taker list by adding a test taker to the test taker list or deleting a test taker from the test taker list; and
(v) revision of the test list by adding a test to the test list or deleting a test from the test list.

9. The method of claim 1, further comprising the server updating the interface in real time to display a current status of a test presentation.

10. A method for testing, comprising:
a client web browser sending a request to a web address;
a server system responding to the request by sending to the client web browser a document defining an interface, the interface identifying a test taker list, a test list, and a dial-out phone number list;
a user selecting a test taker, a test, and a dial-out phone number through the interface;
the server system presenting the test to the test taker through a phone call to the dial-out phone number, wherein the server system records the phone call;
the server system determining a score of the test; and
the server system updating the interface to display the score of the test and to allow the user to playback the recording.

11. A system for test management, comprising:
a client device loaded with a web browser and connected to a data network;
an application server connected to the data network;
a voice communication server communicatively coupled to the application server and to a voice communication network; and
wherein the application server comprises logic (i) to cause the client device to display an interface via the web browser; (ii) to receive from the client device, via the interface, a request to present a test, wherein the request comprises a test identifier, a test taker identifier, and a destination identifier; and (iii) to send a test, corresponding to the test identifier, with the destination identifier to the voice communication server for presentation to the test taker, corresponding to the test taker identifier, over the voice communication network.

12. The system of claim 11, further comprising a test scoring server connected to the data network; wherein the voice communication server is configured to generate a test recording, to send to the application server, from the phone call comprising the presentation of the test to the test taker; wherein the application server further comprises logic (iv) to transfer the test recording to the test scoring server; and wherein the test scoring server is configured to score the test using the test recording and to deliver the score to the application server.

13. The system of claim 12, wherein the application server further comprises logic (v) to update the interface to display the score.

14. The system of claim 13, wherein the application server further comprises logic (vi) to update the interface to associate the score with an option to play back the test recording; and (vii) to play back the test recording through the interface.

15. The system of claim 11, wherein the voice communication server comprises a telephony server, wherein the voice communication network comprises a telephone network, and wherein the destination identifier comprises a dial-out phone number.

16. The system of claim 11, further comprising a testing database, associated with the application server, containing information indexed by test taker identifier or test identifier.

17. The system of claim 16, wherein the application server further comprises logic (iv) to retrieve a test from the testing database using the test identifier; (v) to receive a completed test from the voice communication server; (vi) to score the completed test; and (vii) to send the score, the test identifier, and the test taker identifier to the testing database; and wherein the testing database is configured to store the score and to index the score by test identifier and test taker identifier.

18. The system of claim 16, wherein the application server further comprises logic (iv) to retrieve information indexed in the testing database by the test identifier and the test taker identifier in the testing database; (v) to generate at least one testing recommendation using the retrieved information; and (vi) to update the interface to display the testing recommendation.

19. The system of claim 11, wherein the interface identifies a test taker list and a test list, and wherein a user of the client device generates the request by selecting at least one icon displayed in the interface and associated with a test taker identifier and a test identifier.

20. The system of claim 11, wherein the application server further comprises logic (iv) to update the interface to display a current status of the test presentation.
